(19) United States
(12) Patent Application Publication
(10) Pub. No.: US 2022/0166261 A1
(43) Pub. Date: May 26, 2022

(54) SYSTEMS AND METHODS FOR POWER HARVESTING AND WIRELESS COMMUNICATIONS WITHIN A POWER TOOL SYSTEM

(71) Applicant: Hilti Aktiengesellschaft, Schaan (LI)

(72) Inventors: Marc VETTER, Zurich (CH); Stefan NIKOLOVSKI, Belgrade (RS); Jelena JOVANOVIC, Belgrade (RS); Alfred LUPPER, Aystetten (DE)

(21) Appl. No.: 17/103,451

(22) Filed: Nov. 24, 2020

(51) Int. Cl. H02J 50/80; H01M 10/42; B25B 21/00

(52) U.S. Cl. CPC H02J 50/80; H01M 10/4257; H01M 2010/4278; H01M 2010/4271; B25B 21/00

(57) ABSTRACT

A power tool system includes a power tool configured to receive an input power from a first power device. The power tool system includes a communications device configured to removably couple to an external surface of a housing of the power tool, where the communications device harvests power from the power tool when the communications device is coupled to the external surface of the housing of the power tool. The communications device includes a first wireless mode circuitry configured to receive information from the power tool via a first wireless communications mode and a second wireless mode circuitry configured to transmit information to a remote computing device via a second wireless communications mode. The first and second wireless communication modes are different.

### BACKGROUND

The present disclosure relates generally to the field of power tools, and more particularly to systems and methods for power harvesting and wireless communications within a power tool system.

Electrical devices, such as corded or cordless power tools, may be useful in typical construction job sites. Typically, electrical devices include a motor drive and control circuitry for controlling the motor drive. Certain corded power tools may draw power from a fixed power source, while certain cordless power tools may draw power from a rechargeable power source (e.g., rechargeable battery pack). In certain situations, it may be beneficial to have wireless communications between the power tool and various other components on the construction job site and/or to remote computing devices. However, some power tools may not be equipped with such wireless communications.

Accordingly, it may be beneficial to provide systems and methods for wireless communications for use within a power tool system. Furthermore, it may be beneficial to provide systems and methods for powering the devices providing wireless communications, in order to improve the efficiency and longevity of the power tool system. Specifically, it may be beneficial to provide for methods for harvesting power for a communications device that transmits information obtained from the power tool to other components on the construction job site and/or to remote computing devices.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a power tool system includes a power tool configured to receive an input power from a first power device. The power tool system includes a communications device configured to removably couple to an external surface of a housing of the power tool, where the communications device harvests power from the power tool when the communications device is coupled to the external surface of the housing of the power tool. The communications device includes a first wireless mode circuitry configured to receive information from the power tool via a first wireless communications mode and a second wireless mode circuitry configured to transmit information to a remote computing device via a second wireless communications mode. The first and second wireless communication modes are different.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a power tool system having a power tool, a communications device that harvests power from the power tool, and a computing device, in accordance with aspects of the present disclosure;

FIG. 2 is a block diagram of an embodiment of the power tool system of FIG. 1, where the communications device includes a power source to provide power to operate the communications device, in accordance with aspects of the present disclosure;

FIG. 3 is an embodiment of a method for harvesting power for the communications device from the power tool of FIG. 1, in accordance with aspects of the present disclosure; and

FIG. 4 is an embodiment of a method for powering the communications device of FIG. 1 with an internal power source to enable communications, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Present embodiments are directed to a communications device configured for use within a power tool system on a construction job site. Specifically, the communications device may be a tag (e.g., active Near Field Communication (NFC) tag) communicatively coupled to the power tool and/or the power tool battery. The communications device may be configured to wirelessly receive information (e.g., operating information, historical data, unique identification information, etc.) related to the power tool, and then wirelessly transmit the information to other components on the job site and/or to a remote computing device (smartphone, computer, tablet, mobile device, gateway, or any processor-enabled device). In certain embodiments, the communications device may be configured to receive information with a first wireless mode of communication, convert the information into a second wireless mode of communication, and transmit the converted information to the remote computing device. In certain embodiments, the communications device may be configured to wirelessly transmit information (e.g., lock-down command, operating commands, etc.) from the remote computing device to the power tool and/or the power tool battery. In certain embodiments, the communications device may be configured to receive information with a second wireless mode of communication, convert the information into a first wireless mode of communication, and transmit the converted information to the power tool and/or power tool battery.

In certain embodiments, the communications device may be configured to harvest power from the communications circuitry (e.g., NFC module) of the power tool. In certain embodiments, the communications device may be configured to use an internal power supply (e.g., battery). In certain embodiments, the communications device may be configured to transmit and/or receive information based on the available power and the available power source.

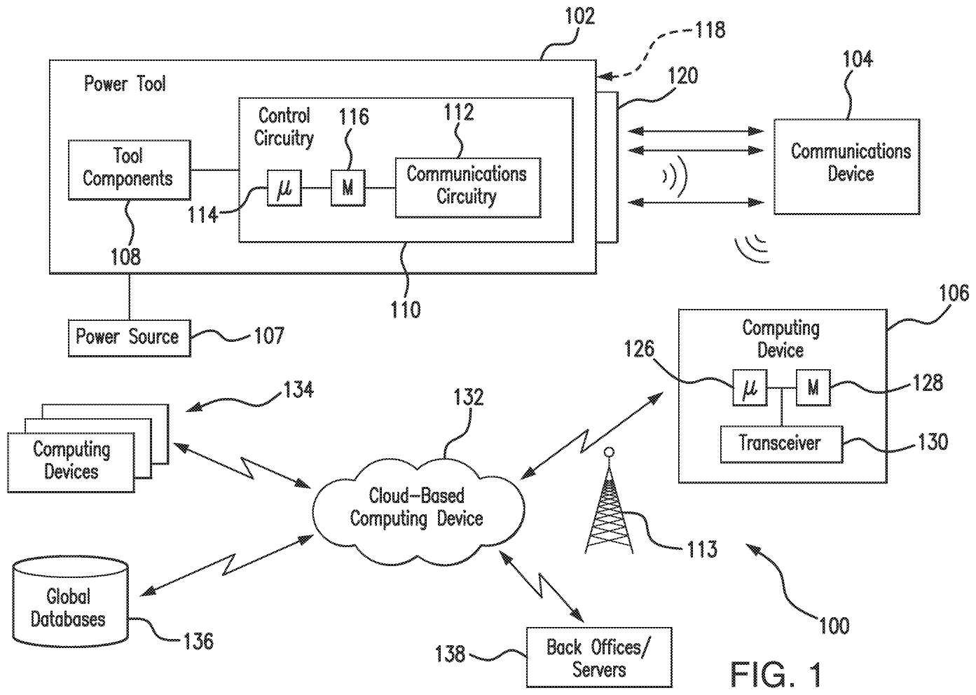

Turning now to the drawings, FIG. 1 is a block diagram of an embodiment of a power tool system 100 having a power tool 102, a communications device 104, and a computing device 106. In certain embodiments, the power tool 102 may be a cordless power tool configured to receive power from a power source 107. In certain embodiments, the power source 107 may be a rechargeable battery pack (e.g., lithium-ion battery pack) that is removably and physically coupled to the power tool 102 via a power interface. In certain embodiments, the power tool 102 may be a corded power tool configured to receive power from a power outlet or a fixed/portable power source. The power tool 102 may include one or more tool components 108, such as, for example, a motor, a trigger, and/or one or more sensors. In certain embodiments, the power tool 102 includes control circuitry 110 having communications circuitry 112, a processor 114, and a memory 116.

The tool components may include one or more sensors such as safety sensors, position and/or orientation sensors, touch sensors, pressure sensors, accelerometers, temperature sensors, proximity and displacement sensors, image sensors, level sensors, gyroscopes, force sensors, speed sensors, safety sensors, etc. In certain embodiments, the accelerometer may be a one-axis, two-axis, or a three-axis accelerometer configured to gather information related to static and dynamic forces. In certain embodiments, the one or more sensors may be configured to gather raw information, such as movement (e.g., movement intensity), touch, pressure, position, orientation, speed, distance, height, vibrations, acceleration, elevation, and so forth, related to the power tool 102. In certain embodiments, the raw sensor information may be associated with time, so that a timeline or chronology of events may be generated. In certain embodiments, the one or more sensors may be configured to gather and/or determine certain operating parameters related to the power tool 102. The operating parameters related to the power tool 102 may include, but are not limited to, historical information related to the operation of the power tool 102 (e.g., runtime), error codes or alerts triggered by the power tool 102, historical information related to the repair and/or theft of the power tool 102, sensor related information gathered from one or more sensors 108 disposed throughout the power tool 102, information related to the components of the power tool 102, drive signals provided by the control circuitry 110 and/or input signals provided by the trigger 108, and/or the general state of the health of the power tool 102. The control circuitry 110 may be configured to receive the raw information and/or operating information related to the power tool 102. In certain embodiments, the control circuitry 110 may be configured to receive or gather other types of information related to the power tool 102, such as, but not limited to, unique identification information related to the power tool 102, unique identification information related to the manufacturer, owner, and/or previous owners of the power tool 102. In certain embodiments, the control circuitry 110 may be configured to determine or calculate other parameters (e.g., calculated parameters) related to the power tool 102, such as height, distance, velocity, force of impact, free-fall distance, free-fall height, usage total time, transportation total time, idle time, or other similar information derived from the raw information.

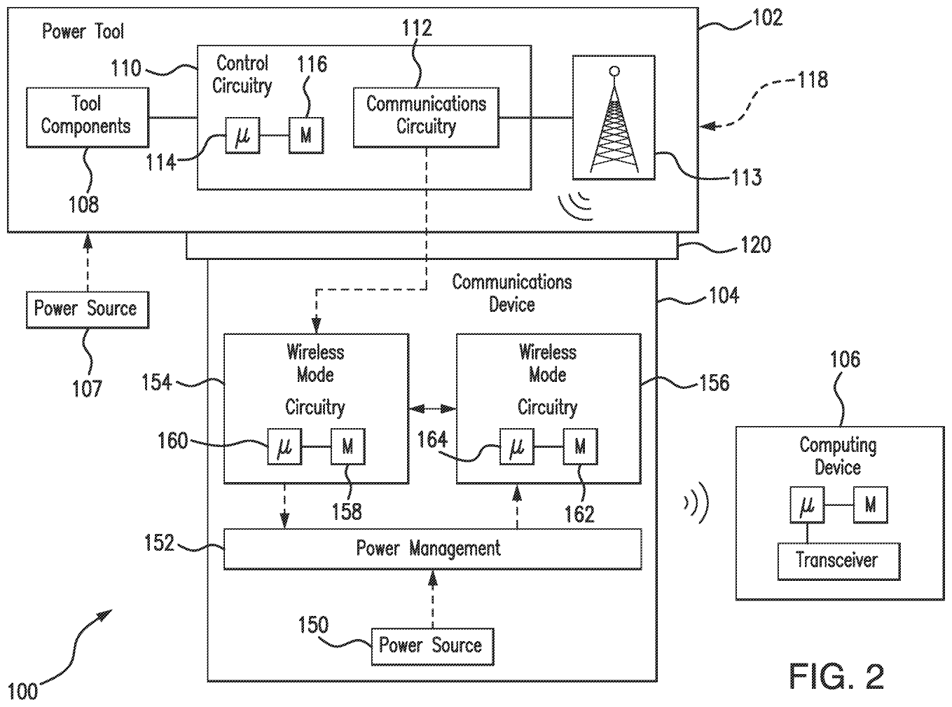

The power source 107 may be configured to provide power to operate the motor of the power tool 102. In certain embodiments, the motor may be any type of electric motor that may receive power from an appropriate source (e.g., electrical, pneumatic, hydraulic, etc.). In certain embodiments, the tool components 108, such as the trigger and the motor, may be communicatively coupled to the control circuitry 110. Engaging various functions of the trigger may enable functionality of the power tool 104. For example, engaging the “ON” or “OFF” features of the trigger may provide an input to the control circuitry 110, which in turn may provide a drive signals to the motor. In certain embodiments, the power source 107 may be configured to provide power for the tool components 108, the control circuitry 110, and/or the communications circuitry 112 of the power tool 102. Further, in certain embodiments, power may be transferred from the power tool 102 to devices external to the power tool 102 (e.g., communications device 104), as further described with respect to FIG. 2.

In certain embodiments, the communications device 104 may be a wireless communications tag that is communicatively coupled to the communications circuitry 112 of the power tool 102. For example, the communications device 104 may be configured to receive information (e.g., raw information, operating parameters, calculated parameters, historical information, unique identification information, etc.) from the communications circuitry 112, which may be configured to transmit information gathered and stored within the memory 116 of the control circuitry 110. In the illustrated embodiment, the communications circuitry 112 may include a dynamic active NFC module and/or antenna 113 configured to wirelessly communicate information to the communications device 104. The antenna 113 may be disposed within the communications circuitry 112 or outside of the control circuitry 110, to enable ease of wireless communications. In certain embodiments, the antenna 113 may be disposed on the inner wall of the housing of the power tool 102. In certain embodiments, the antenna 113 is not disposed on the inner wall of the housing of the power tool 102.

While the illustrated embodiment depicts the communications circuitry 112 as an NFC module and/or antenna, it should be noted that the communications circuitry 112 may be include circuitry for any form of wireless communications (e.g., Bluetooth, Wifi, ZigBee, LoRa, LoRaWAN, Sigfox, Cellular, etc.). The communications device 104 may be configured to wirelessly transmit and/or receive information with one or more modes of communication, such as, for example, Bluetooth, Near Field Communication (NFC), Wifi, ZigBee, LoRa, LoRaWAN, Sigfox, Cellular, etc. In particular, in certain embodiments, the communications device 104 may be configured to receive information with a first wireless mode of communication, convert the information into a second wireless mode of communication, and transmit the converted information to the remote computing device 106, as further described with respect to FIG. 2. In certain embodiments, the communications device 104 may be configured to advertise a signal at pre-determined intervals, until the computing device 106 within a pre-determined proximate distance receives the signal and establishes a communication channel with the communications device 104. In certain embodiments, the communications device 104 may be configured to transmit an information packet with raw information, operating parameters, calculated parameters, and/or any other type of information available for the power tool 102.

In certain embodiments, the communications device 104 may be removably attached to the power tool 102, such that it is coupled to an external surface 118 of a housing assembly of the power tool 102. For example, the communications device 104 may be attached directly to the external surface 112 of the housing assembly via an adhesive, a tape, one or more fastening devices, or any form of attachment means that allows the communications device 104 to be removably engaged with the housing assembly. The communications device 104 may be attached anywhere on the external surface 112 of the housing assembly. In certain embodiments, the communications device 104 may be removably engaged within a cavity 120 (e.g., sleeve, compartment, etc.) of the housing assembly, such that the cavity 120 is permanently disposed on the external surface 118 of the housing assembly. The cavity 120 may be designed to house the communications device 104, prevent the communications device 104 from accidentally dislodging, and protect the communications device 104 from environmental factors or impact. The communications device 104 may be configured to adapt and/or conform to the shape of the cavity 122 when it is removably inserted within the cavity 120. In certain embodiments, the communications device 104 may be remote from the power tool 102, such that it is coupled to a device proximate to the power tool 102. In certain embodiments, the communications device 104 may be accidentally dislodged or removed from the power tool 102.

The remote computing device 106 (e.g., smartphone, computer, tablet, mobile device, gateway, or any processor-enabled device) may include a processor 126 configured to execute instructions stored on a memory 128. Further, the remote computing device 106 may include a transceiver 130 (e.g., configured for NFC, Wifi, Bluetooth, etc.) that is configured to communicate the information received from the communications device 104 to a cloud-based computing device 132 via a wired connection or wireless connection. For example, the wireless protocols utilized may include WiFi (e.g., Institute of Electrical and Electronics Engineers [IEEE] 802.11X, cellular conduits (e.g., high speed packet access [HSPA], HSPA+, long term evolution [LTE], WiMax), near field communications (NFC), Bluetooth, personal area networks (PANs), and the like. The cloud-based computing device 132 may be a service provider providing cloud analytics, cloud-based collaboration and workflow systems, distributed computing systems, expert systems and/or knowledge-based systems. In certain embodiments, the cloud-based computing device 132 may be a data repository that is coupled to an internal or external global database 136.

Further, in certain embodiments, the global database 136 may allow computing devices 134 to retrieve information stored within for additional processing or analysis. Indeed, the cloud-based computing device may be accessed by a plurality of systems (computing devices 134 and/or computing devices from back offices/servers 138) from any geographic location, including geographic locations remote from the physical locations of the systems. Accordingly, the cloud 132 may enable advanced collaboration methods between parties in multiple geographic areas, provide multi-party workflows, data gathering, and data analysis, which may increase the wireless capabilities of connectivity of the power tool 102.

FIG. 2 is a block diagram of an embodiment of the power tool system 100 of FIG. 1, where the communications device 104 includes a second power source 150 to provide power to the communications device 104. In particular, the communications device 104 may be configured to utilize one or more different power sources in order to receive, store, and utilize power for operation and wireless communications. For example, in certain embodiments, when the communications device 104 is attached to the power tool 102, via the cavity 120 or directly coupled to the external surface 118, power may be transferred from the power tool 102 to the power management 152 component of the communications device 104. In certain embodiments, when the communications device 104 is not attached to the power tool 102, the communications device 104 may draw power from the internal power source 150. In this manner, the communications device 104 may be configured to harvest power directly from the power tool 102 when the communications device 104 is coupled to the power tool 102. Further, the communications device 104 may be configured to utilize a backup internal power source (e.g., the second power source 150) when the communications device 104 is not coupled to the power tool 102.

Specifically, in certain embodiments, the communications device 104 may be configured to receive power from the communications circuitry 112 of the power tool 102. For example, as noted above, the illustrated embodiment depicts the communications circuitry 112 as an NFC module that utilizes an antenna 113 to wirelessly transmit information to the communications device 104. When the communications device 104 is removably attached to the power tool 102 (e.g., removably coupled to the external surface 118 or disposed within the cavity 120), the communications device 104 may be configured to harvest power directly from the NFC module. Specifically, the communications device 104 may be configured to receive power via the power management 152 component, and may be configured to either store or distribute the power as needed.

In certain embodiments, the communications device 104 may be configured to utilize a backup power source (e.g., the second power source 150) when the communications device 104 is not removably coupled to the power tool 102. For example, in certain embodiments, the communications device 104 may be remote from the power tool 102, such that it is coupled to a device proximate to the power tool 102, accidentally dislodged or removed from the power tool 102, and/or disposed at a fixed location proximate from the power tool 102. In certain embodiments, the power tool 102 may be powered “OFF.” In such situations, the communications device 104 may source power from the second power source 150, which may be an internal battery source.

In certain embodiments, the communications device 104 may be configured to receive information with a first wireless mode of communication, convert the information into a second wireless mode of communication, and transmit the converted information to the remote computing device 106, as further described with respect to FIG. 2. For example, in certain embodiments, the communications device 104 may be configured to receive information via a first wireless mode circuitry 154, which may be one of Bluetooth, Near Field Communication (NFC), Wifi, ZigBee, LoRa, LoRaWAN, Sigfox, Cellular, etc. After converting the information into a second wireless mode of communication, the communications device 104 may be configured to transmit the converted information via the second wireless mode circuitry 156, which may be one of Bluetooth, Near Field Communication (NFC), Wifi, ZigBee, LoRa, LoRaWAN, Sigfox, Cellular, etc. In particular, the first and second wireless modes 154, 156 may be the same wireless modes or different wireless modes of communication. In the illustrated embodiment, the communications device 104 may be configured to receive information via NFC from the communications circuitry 112 (e.g., NFC module) of the power tool 102 with the first wireless mode circuitry 154. Further, the communications device 104 may be configured to convert and transmit the information with the second wireless mode circuitry 154. Specifically, the second wireless mode circuitry 154 may be configured for converting and transmitting the information via Bluetooth to the computing device 106.

In certain embodiments, information received from the power tool 102 (e.g., via a first wireless mode of communications, such as NFC) is stored within a first memory 158 associated with the first wireless mode circuitry 154. Accordingly, if the communications device 104 loses power and/or a source of power, the information stored within the first memory 158 may remain accessible at a future time. Subsequently, the second wireless mode circuitry 156 may be configured to convert the contents of the first memory 158 into two advertising packets, for transferring via a second mode of wireless communications (e.g., BLE) to the computing device 106. In certain embodiments, the first advertising packet includes information related to the unique identification of the communications device 104. Further, in certain embodiments, the second advertising packet includes information related to the power tool 102. In certain embodiments, the communications device 104 may be configured to continue transferring first and second packets of information at a predetermined interval (e.g., 1 second, 2 seconds, 3 seconds, 4 seconds, 5 seconds, etc.) as long the communications device 104 is powered and/or has a power source available.

In certain embodiments, the second wireless mode circuitry 156 may be configured to convert the contents of the first memory 158 into a single first advertising packet, for transferring via a second mode of wireless communications (e.g., BLE) to the computing device 106. For example, the single first advertising packet may include information related to the unique identification of the communications device 104 and the information related to the power tool 102. The communications device 104 may be configured to continue transferring the single first advertising packet at a predetermined intervals (e.g., 1 second, 2 seconds, 3 seconds, 4 seconds, 5 seconds, etc.) as long the communications device 104 is powered and/or has a power source available. In certain embodiments, three or more advertising packets may be utilized to transferring information to the computing device 106.

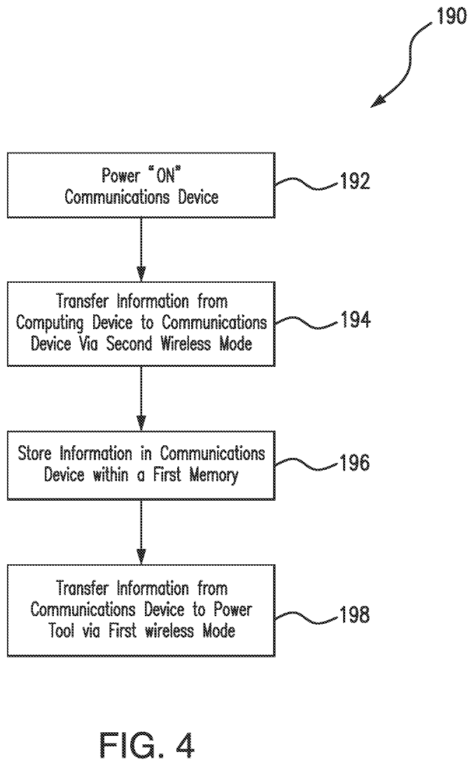

As further described with respect to FIG. 4, the second wireless mode circuitry 156 may be configured to receive information from the computing device 106 via the second mode of wireless communications (e.g., BLE), and may store the information in a second memory 162 associated with the second wireless mode circuitry 156. In certain embodiments, the first and second wireless mode circuitry 154, 156 may utilize a single memory 158, and information received at the communications device 104 may be stored in different locations within the single memory 158. In certain embodiments, the first wireless mode circuitry 154 may be configured to convert the information received into the first mode of wireless communications (e.g., NFC) for transfer to the power tool 102.

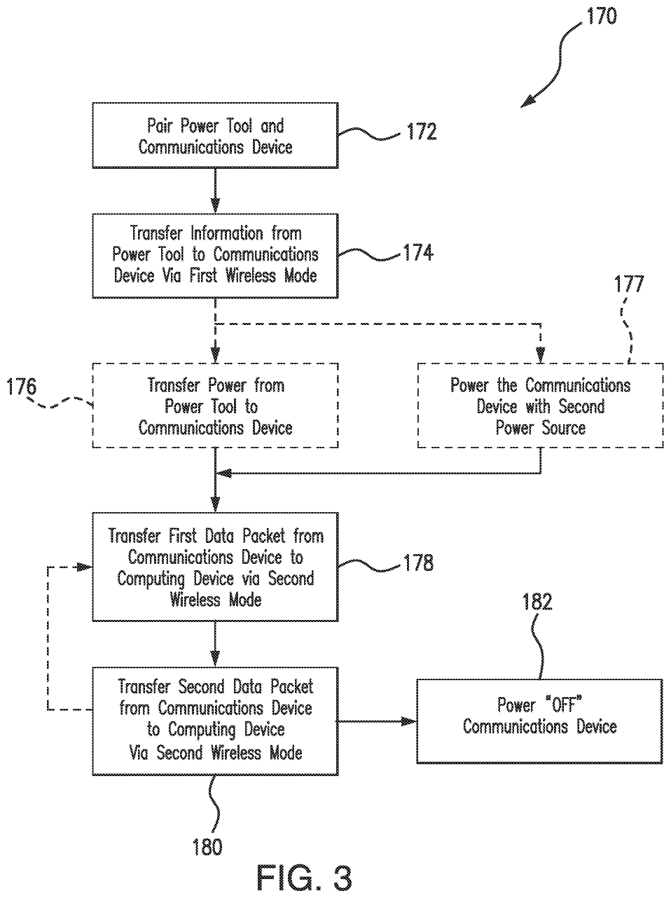

FIG. 3 is an embodiment of a method for harvesting power for the communications device 104 from the power tool 102 of FIG. 1. First, the method 170 includes pairing the power tool 102 and the communications device 104 (block 172). Specifically, the first wireless mode circuitry 154 may be configured to pair with the communications circuitry 112 of the power tool 102. In certain embodiments, the first wireless mode circuitry 154 and the communications circuitry 112 may be configured to communicate with the same wireless mode of communications, such as, for example, NFC.

In certain embodiments, the method 170 includes transferring information from the power tool 102 to the communications circuitry 114 (block 174). For example, the information transferred may include raw sensor information (e.g., movement, movement intensity, touch, pressure, position, orientation, speed, distance, height, vibrations, acceleration, elevation, etc.), certain operating parameters (e.g., historical information, runtime, error codes, alerts, drive signals, input signals, etc.), unique identification information related to the power tool 102, and/or calculated parameters (e.g., height, distance, velocity, force of impact, free-fall distance, free-fall height, usage total time, transportation total time, idle time, or other similar information derived from the raw information).

In certain embodiments, the method 170 includes transferring power from the power tool 102 to the communications device 104 (block 176) or powering the communications device 104 with the second power source 150 (block 177). Specifically, when the communications device 104 is attached to the power tool 102, via the cavity 120 or directly coupled to the external surface 118, power may be transferred from the power tool 102 to power management 152 component of the communications device 104. Further, when the communications device 104 is not attached to the power tool 102, the power tool 102 is turned “OFF,” or the power tool 102 is not receiving power from the power tool battery, the communications device 104 may draw power from the internal power source 150.

In certain embodiments, the method 170 includes transferring a first data packet from the communications device 104 to the computing device 106 via the second wireless mode circuitry 156 (block 178) and transferring a second data packet from the communications device 104 to the computing device 106 via the second wireless mode circuitry (block 180). Specifically, the communications device 104 may be configured to receive information with a first wireless mode of communication (via the first wireless mode circuitry 154), convert the information into a second wireless mode of communication, and transmit the converted information to the remote computing device (via the second wireless mode circuitry 156). For example, in certain embodiments, information received from the power tool 102 (e.g., via a first wireless mode of wireless communications, such as NFC) is stored within the first memory 158 associated with the first wireless mode circuitry 154. Further, the second wireless mode circuitry 156 may be configured to convert the contents of the first memory 158 into two advertising packets, for transferring via a second mode of wireless communications (e.g., BLE) to the computing device 106. In certain embodiments, the first advertising packet includes information related to the unique identification of the communications device 104. Further, in certain embodiments, the second advertising packet includes information related to the power tool 102. As noted above, the communications device 104 may be configured to continue transferring first and second packets of information at a predetermined intervals (e.g., 1 second, 2 seconds, 3 seconds, 4 seconds, 5 seconds, etc.) as long the communications device 104 is powered and/or has a power source available. In certain embodiments, the second wireless mode circuitry 156 may be configured to convert the contents of the first memory 158 into a single first advertising packet, for transferring via a second mode of wireless communications (e.g., BLE) to the computing device 106. For example, the single first advertising packet may include information related to the unique identification of the communications device 104 and the information related to the power tool 102. The communications device 104 may be configured to continue transferring the single first advertising packet at a predetermined intervals (e.g., 1 second, 2 seconds, 3 seconds, 4 seconds, 5 seconds, etc.) as long the communications device 104 is powered and/or has a power source available. In certain embodiments, three or more advertising packets may be utilized to transferring information to the computing device 106.

In this manner, the communications device 104 retroactively enables wireless communications for the power tool 102 having only a particular mode of wireless communications. In certain embodiments, the communications device 104 may be powered off, and communications may be temporarily paused (block 182).

FIG. 4 is an embodiment of a method 190 for powering the communications device 104 of FIG. 1 with an internal power source 150 to enable communications. In certain embodiments, the method 190 includes powering the communications device “ON” by utilizing either power from the power tool 102 or the second (internal) power source 150 (block 192). Further, the method 190 includes transferring information from the computing device 106 to the communications device 104 with the second wireless mode circuitry 156 (block 194). The method 190 includes storing the information within the communications device 104 in the first memory 158 and/or the second memory 162 (block 196). In certain embodiments, there may be a single memory 158 associated with the first and second wireless mode circuitry 154, 156. Further, the method 190 includes transferring information from the communications device 104 to the power tool 102 via the first wireless mode circuitry 154 (block 198).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed:

1. A power tool system, comprising:
a power tool configured to receive an input power from a first power device;
a communications device configured to removably couple to an external surface of a housing of the power tool, wherein the communications device harvests power from the power tool when the communications device is coupled to the external surface of the housing of the power tool, and wherein the communications device comprises:
a first wireless mode circuitry configured to receive information from the power tool via a first wireless communications mode; and
a second wireless mode circuitry configured to transmit information to a remote computing device via a second wireless communications mode, wherein the first and second wireless communication modes are different.

2. The power tool system of claim 1, wherein the communications device harvests power from a communications circuitry of the power tool when the communications device is coupled to the external surface of the housing of the power tool.

3. The power tool system of claim 1, wherein an internal power source is configured to power the communications device when the communications device is removed from the external surface of the housing of the power tool.

4. The power tool system of claim 1, wherein an internal power source is configured to power the communications device when the power tool is tuned “OFF” or the power tool does not receive power from a power tool battery.

5. The power tool system of claim 1, wherein the first power device is a rechargeable battery pack comprising a series of rechargeable lithium-ion battery cells.

6. The power tool system of claim 1, wherein the communications device comprises a memory configured to store information received from the power tool via the first wireless communications mode.

7. The power tool system of claim 1, wherein the communications device converts the stored information for transmission via the second wireless communications mode.

8. The power tool system of claim 7, wherein the communications device transmits the stored information to a remote computing device via the second wireless communications mode.

9. The power tool system of claim 1, wherein the first and second wireless communication modes comprise Bluetooth, Near Field Communication (NFC), Wifi, ZigBee, Cellular, LoRa, LoRaWAN, Sigfox or a combination thereof.
